(19) United States
(12) Patent Application Publication
(10) Pub. No.: US 2009/0313648 A1
(43) Pub. Date: Dec. 17, 2009

(54) AUDIO/VIDEO DISTRIBUTION APPARATUS

(75) Inventors: Kamal Jain, Bellevue, WA (US); Denis Xavier Charles, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/137,565

(22) Filed: Jun. 12, 2008

(51) Int. Cl. H04N 7/16; H04N 7/173

(52) U.S. Cl. 725/5; 725/104

(57) ABSTRACT

An apparatus is described herein, wherein the apparatus includes a housing, wherein the housing includes a first aperture and a second aperture. The apparatus also includes a display screen that is located in the first aperture of the housing. An interface module may be located in the second aperture of the housing, wherein the interface module can be configured to receive a portable memory device. The apparatus also includes a data store that is communicatively coupled to the interface device, wherein the data store includes a plurality of movies available for rental.

### BACKGROUND

The movie industry is a multi-billion dollar industry. Revenue is generated from individuals travelling to a theater and attending movies that are relatively new releases, and further revenue is generated from rental of the movies at a later period in time. Conventionally, the movie rental business has been associated with “brick and mortar” retail stores, where individuals select movies in a physical medium for rental. For example, if an individual wished to rent a particular movie, the individual typically will travel to a movie rental location, search for the particular movie (e.g., in the form of a DVD), checkout the movie, and thereafter take the movie to a residence. If the particular movie is not in stock, the individual can choose another movie or leave empty handed. The individual will generally have a threshold amount of time to watch the movie (e.g., three days). Prior to passage of the threshold amount of time, the individual must travel back to the movie rental location and return the movie. It can be discerned that the travel back and forth to the movie rental location can inconvenience individuals, particularly individuals who do not reside nearby the movie rental location.

To address this deficiency, a portion of the movie rental business has transitioned to a mail order business. More specifically, an individual can pay a monthly fee for a mail order movie rental service, and can receive movies selected at an online site by way of the mail. While this addresses deficiencies corresponding to travel to rent movies, the individual must determine which movie she would like to view several days prior to actually viewing the movie. Thus, the individual cannot rent a movie on impulse.

Recently, cable providers have begun renting movies by streaming selected movies to a set top box for a fee. This approach allows individuals to rent an available movie when the impulse strikes without having to travel to a movie rental location. Furthermore, if the movie is shown as being available for rent, then the individual is assured that they can view the movie. Cable providers, however, are currently able to offer a relatively limited number of movies for rent, and such movies are not portable (e.g., one could not rent a movie by way of the cable provider and watch such movie on a laptop computer on an airplane).

Currently, an industry pertaining to downloading of movies is poised for massive growth. More specifically, services exist that allow an individual to employ a high speed Internet connection to retrieve a selected movie for a fee. The movie may then be watched on a computing device or on a television (if the television has the appropriate hardware/software for connecting to a broadband Internet connection). Many individuals, however, do not have high speed Internet access, and do not have devices that allow downloaded movies to be played on a portable television. While downloaded movies can be watched from a laptop computer, if an individual is travelling the individual must determine which movie or movies to rent far in advance of travelling.

### SUMMARY

The following is a brief summary of subject matter that is described in greater detail herein. This summary is not intended to be limiting as to the scope of the claims.

Described herein are various technologies pertaining to movie purchase or rental. More particularly, transmission of a movie to a portable flash memory device is described herein. An apparatus described herein may be relatively small in size, and may include a data store that includes a plurality of movies that are available for rental or purchase. Furthermore, the apparatus can include a display screen that is configured to present a graphical user interface to a user, such that the user can search for a movie that is desirably rented or purchased. The apparatus may additionally include an interface module that is configured to receive a portable memory device, such as a Universal Serial Bus memory device. Once the user has coupled the portable memory device to the apparatus by way of the interface module, a selected movie can be transferred from the data store in the apparatus to the portable memory device.

The user may pay for the selected movie by way of any suitable payment mechanism. For instance, the apparatus may be configured to accept cash as payment. In another example, the apparatus may be configured to accept electronic funds that are retained in the portable memory apparatus as payment. In yet another example, the apparatus may be configured to accept credit or debit card payments. Once payment for the movie has been received, a cryptographic key that can be employed to decrypt the selected movie may be transmitted to the portable memory device. Thus, the user may not view the movie until payment has been received.

In an example, an individual at an airport may have a laptop, and may be preparing to depart on a relatively long flight. The individual may desire to watch a movie on the flight, but may have forgotten to select a movie prior to travelling to the airport. The individual may have a portable memory device, such as a USB flash memory device. The individual can locate the apparatus, select a movie, and have such movie transmitted to the portable memory device. The user may then watch the movie from the portable memory device while in flight.

Other aspects will be appreciated upon reading and understanding the attached figures and description.

### BRIEF DESCRIPTION OF THE DRAWINGS

FIG. 1 is a functional block diagram of an example apparatus that facilitates transmission of a rental movie to portable memory device.

FIG. 2 is an example depiction of an example apparatus that facilitates transmission of a rental movie to a portable memory device.

FIG. 3 is a functional block diagram of a memory and contents thereof.

FIG. 4 is a functional block diagram of an example apparatus that facilitates providing transmission of a rental movie to a portable memory device.

FIG. 5 is an example timing diagram.

FIG. 6 is a flow diagram that illustrates an example methodology for transmitting a movie to a portable memory device.

FIG. 7 is a flow diagram that illustrates an example methodology for transmitting a cryptographic key to a portable memory device, wherein the cryptographic key allows a movie on the portable memory device to be viewed.

FIG. 8 is a flow diagram that illustrates an example methodology for altering content of a data store that includes a plurality of rentable movies.

FIG. 9 is a flow diagram that illustrates an example methodology for receiving payment from a user for a movie rental.

FIG. 10 is an example computing system.

### DETAILED DESCRIPTION

Various technologies pertaining to distribution of rental movies, and a stand-alone movie rental apparatus in particular, will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

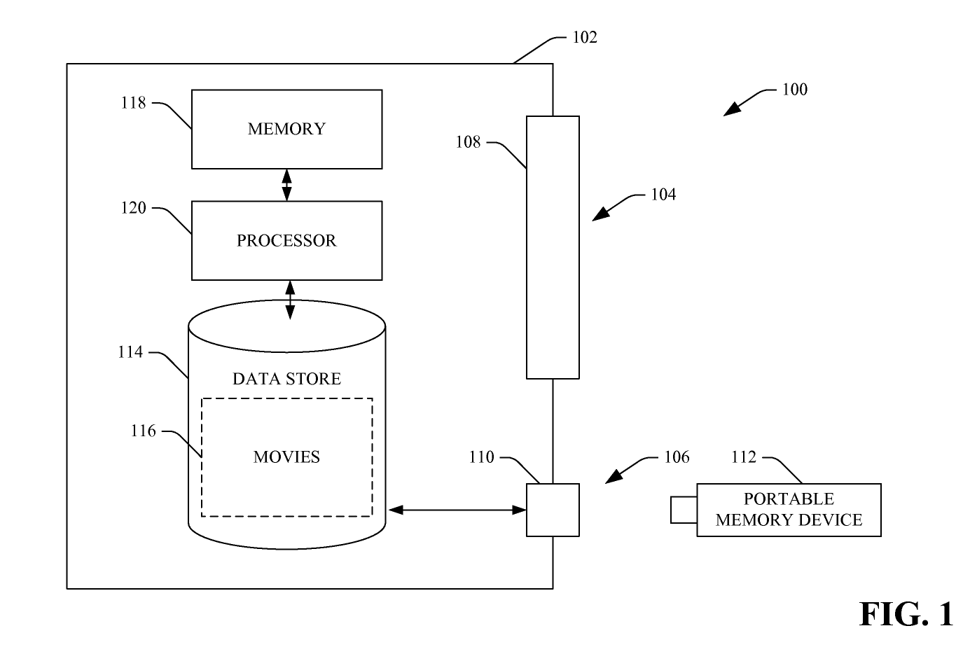

With reference to FIG. 1, an example apparatus 100 that facilitates distribution of movies is illustrated. Pursuant to an example, the apparatus 100 may be desirably placed in an airport, at a grocery store, a gas station, a convenience store, or other suitable location. Furthermore, the apparatus 100 may be a stand-alone apparatus, wherein rentable/purchaseable movies are retained in the apparatus 100. As used herein, the term “stand-alone” can indicate that movies are stored locally at the apparatus in a data store, such as a hard drive.

The apparatus 100 includes a housing 102, which may be made of any suitable material, including a metal, a hard plastic, a carbon-fiber material, etc. The housing 102 can include a first aperture 104 and a second aperture 106. The apparatus 100 can also include a display screen 108 that is positioned in the first aperture 104 of the housing 102. Pursuant to an example, the display screen 108 may be a liquid crystal display (LCD) screen, may be a cathode ray tube display screen, a plasma display screen, or any other suitable display screen. Furthermore, the display screen 108 may be a touch-sensitive screen.

The apparatus 100 can additionally include an interface module 110 that is located in the second aperture 106 of the housing 102 and, for instance, may be accessed on the exterior of the housing 102. The interface module 110 may be configured to receive a portable memory device 112, such as a DVD, a flash memory device, such as a Universal Serial Bus (USB) flash drive, a secure digital card, or other suitable portable memory device. Thus, the interface module 110 may be or include a USB port, a DVD drive that is configured to write to blank DVDs, a firewire port, etc.

The apparatus 100 may also include a data store 114 that is communicatively coupled to the interface module 110, wherein the data store 114 includes a plurality of movies 116 that are available for rental or purchase to a user. As used herein, the term “movies” is meant to include feature films, television programs, television series, etc. Pursuant to an example, the data store 114 may include storage space of a terabyte. In another example, the data store 114 may include storage space of five terabytes. In still yet another example, the data store 114 may include storage space of ten terabytes. The movies 116 in the data store 114 may include digital rights management restrictions (DRM), for instance.

The apparatus additionally includes a memory 118 that includes a plurality of instructions, and a processor 120 that can execute the instructions in the memory 118. For instance, the memory 118 can include instructions for displaying a graphical user interface on the display screen 108, wherein the graphical user interface is configured to receive a selection of a movie from amongst the plurality of movies 116 in the data store 114. For instance, the graphical user interface may display a list of movies that are available in the data store 114, and the user may select one or more of such movies (e.g., by selecting with a finger, a keyboard, a mouse, . . . ).

The memory 118 can also include instructions for transmitting a selected movie from the data store 114 to the portable memory device 112 by way of the interface module 110. For example, if the portable memory device 112 is a flash memory device, a full length movie may be transferred from the data store 114 to the portable memory device 112 in a matter of seconds. As noted above, a movie transferred to the portable memory device 112 may include one or more DRM restrictions. For instance, the one or more restrictions may include a restrictive time window within which a movie can be watched by the user. In an example, the DRM restrictions may allow the user to watch the movie over a twenty four hour period but may not allow the user to watch the movie upon expiration of the 24 hour period. In another example, the DRM restrictions may include a restriction on a number of times that the user can watch the movie. In still yet another example, DRM restrictions may include a restriction on transfer of the movie (e.g., the movie cannot be transferred from the portable memory device 112).

The memory 118 can also include instructions for processing payment for the selected movie. Pursuant to an example, electronic funds may be transferred from the portable memory device 112 to the apparatus 100. More particularly, the portable memory device 112 may be configured to retain a relatively small amount of electronic money, and a portion of such money may be transferred to the apparatus 100 for payment for the movie. In another example, the apparatus 100 may include a cash acceptor, and the memory 118 can include instructions for processing cash payments. In still yet another example, the apparatus 100 may include a card reader that can read credit and/or debit cards, and the memory 118 may include instructions for processing payments from credit and/or debit cards. More particularly, the memory 118 may include instructions for charging a debit card or credit card a fee for renting or purchasing a movie. Furthermore, the memory 118 may include instructions for transmitting a cryptographic key to the portable memory device 112 after payment has been processed. In yet another example, the memory 118 may include instructions for processing payment for rental or purchase of a movie from an online account.

In an example operation of the apparatus 100, a user may approach the apparatus 100 and review movies available for rent or purchase on a graphical user interface presented on the display screen 108. That is, the display screen 108 can display a subset of a plurality of movies that are available for rental or purchase by way of the apparatus 100. If the user locates a movie that is desirably rented or purchased, the user can couple the portable memory device 112 with the interface module 110. The user, before or after coupling the portable memory device 112 with the interface module 110, can select one or more movies that are desirably rented or purchased on the graphical user interface. A selected movie, which can include DRM restrictions, may then be transmitted to the portable memory device 112. While the movie is being transmitted to the portable memory device 112, the user can pay for the movie. Once payment has been processed, a cryptographic key that allows the movie to be accessed can be transmitted to the portable memory device 112.

While the above discussion refers to the apparatus 100 as including movies, it is to be understood that the apparatus 100 may be adapted to transfer music to a portable memory device, such as a portable media player that includes flash memory.

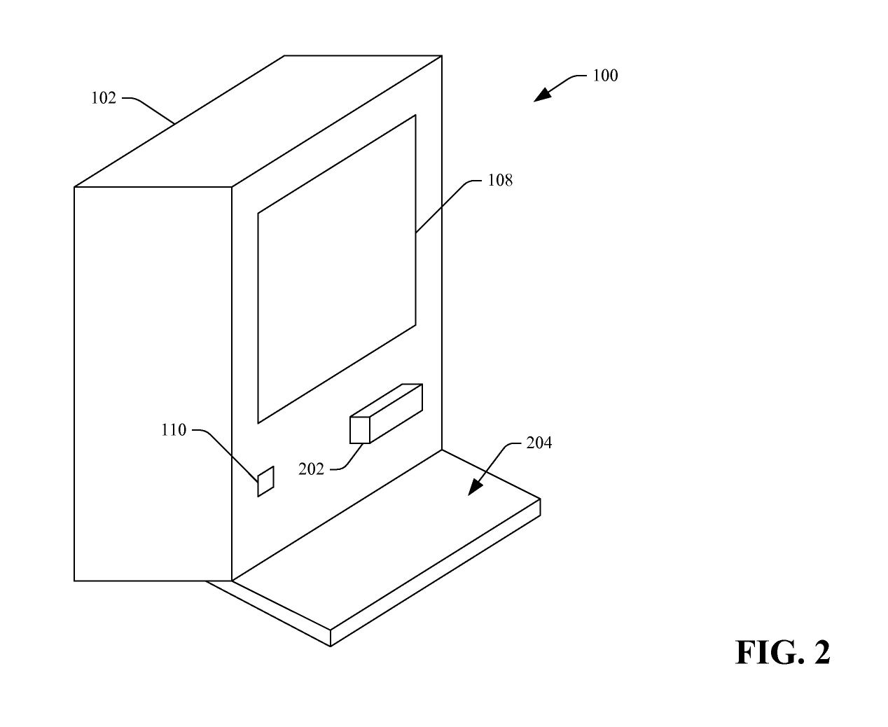

With reference now to FIG. 2, an example movie distribution apparatus 200 is illustrated. Pursuant to an example, the apparatus 200 may be approximately the size of a public telephone. For instance, the apparatus 200 may have a volume of less than eight cubic feet. As noted above, the apparatus 200 includes the housing 102. The display screen 108 can be configured to display a graphical user interface to the user, wherein the graphical user interface depicts movies available for purchase and/or rent. The apparatus 200 also includes the interface module 110 that is accessible from the exterior of the housing 102. As noted above, the interface module 110 can be configured to receive a portable flash memory device, such as a USB device. Thus, the interface module 110 may be or include a USB port that can receive a USB device (e.g., a flash memory device).

The apparatus 200 may additionally include a payment device 202 that can facilitate receipt of payment for a movie from a user. For instance, the payment device 202 may include a cash acceptor that is configured to receive cash (e.g., paper currency) from the user. In another example, the payment device 202 may include a cash dispenser that can distribute change to the user. Moreover, the payment device 202 may include a card reader that can read a magnetic stripe on a credit card and/or debit card. In still yet another example, the payment device 202 may include a bar code reader that can read a bar code. Furthermore, the payment device 202 may include an RFID reader that can receive payment by way of an RFID tag. In yet another example, the payment device 202 may include a component that can be used to process an online payment for rental or purchase of a movie. Other mechanisms for accepting payment for movies are also contemplated and are intended to fall under the scope of the hereto-appended claims.

Furthermore, a keyboard 206 may extend from the housing and be used in connection with searching for movies and/or selecting a movie item for rental or purchase. For example, the display screen 108 may display a graphical user interface that includes a search field, and the apparatus 200 may receive a textual query from a user. Contents of the data store 114 may be searched, and one or more movies corresponding to the search can be presented on the display screen 108. The user may then select a movie for rental or purchase or may modify the search or proffer a new search. Furthermore, a selection device (not shown) such as a mouse may be used to select a movie.

In another example, the apparatus 200 may be connected to a network, such as the Internet, and the keyboard 206 may be used to login to an online account. For instance, the apparatus 200 may include a browser application, and a user may direct the browser to an online account. The user may use the keyboard 206 in connection with entering a username, password, personal identification number, and/or the like. Monies in the online account may be used to purchase one or more movies.

Additionally or alternatively, as noted above, the display screen 108 may be a touch-sensitive screen. The display screen 108 may present a graphical user interface to the user, wherein the graphical user interface may include a plurality of selectable alphanumerical characters. Thus, the user can search for a movie by selecting one or more alphanumerical characters on the graphical user interface, for instance, with a finger. Selection of the movie may initiate transmission of the movie to a portable memory device. Furthermore, the touch-sensitive screen may be used to initiate a browser, direct a browser to an online account, and direct payment for one or more selected movies.

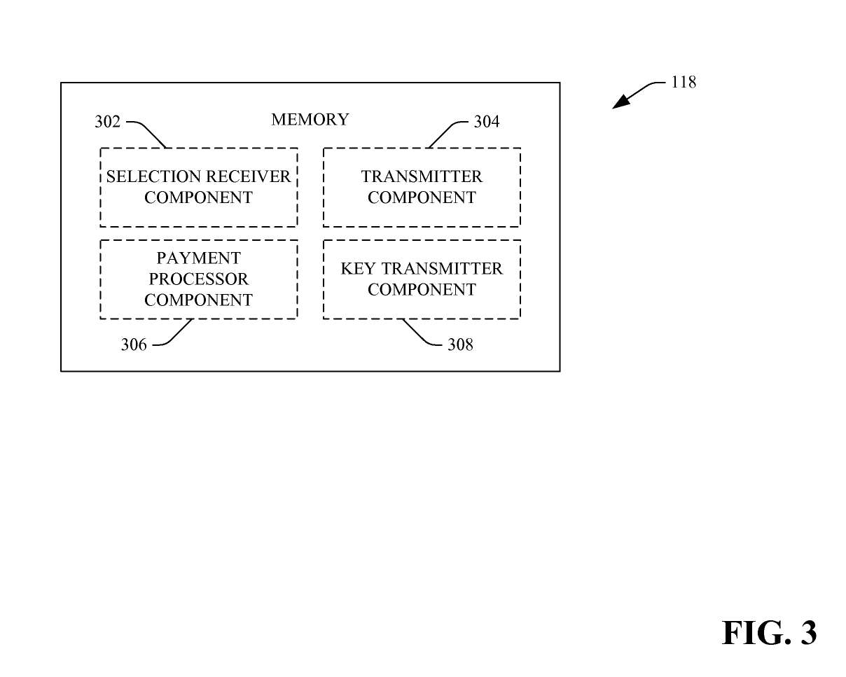

Referring now to FIG. 3, an example depiction 300 of the memory 118 that may be included in the apparatus 100 is illustrated. The memory 118 may include, for example, a selection receiver component 302 that is configured to receive a selection of a movie from a user, wherein the movie is desirably rented or purchased by the user. The selection may be a keystroke on a keyboard, depression of a particular button on the display screen 108 (FIG. 1), etc. The memory 118 may further include a transmitter component 304 that is configured to transmit the movie from the data store 114 (FIG. 1) to the portable memory device 112 upon receipt of the selection of the movie.

Moreover, the memory 118 can include a payment processor component 306 that is configured to process payment for the movie. For instance, the payment processor component 306 may be configured to receive and process a credit card payment, a cash payment, a debit card payment, payment by way of electronic funds stored in a portable memory device, and/or the like. Furthermore, the memory 118 may comprise a key transmitter component 308 that is configured to transmit of a cryptographic key to the portable memory device that corresponds to a selected movie, wherein the cryptographic key can be used to decrypt the movie (e.g., without the cryptographic key, the movie cannot be accessed).

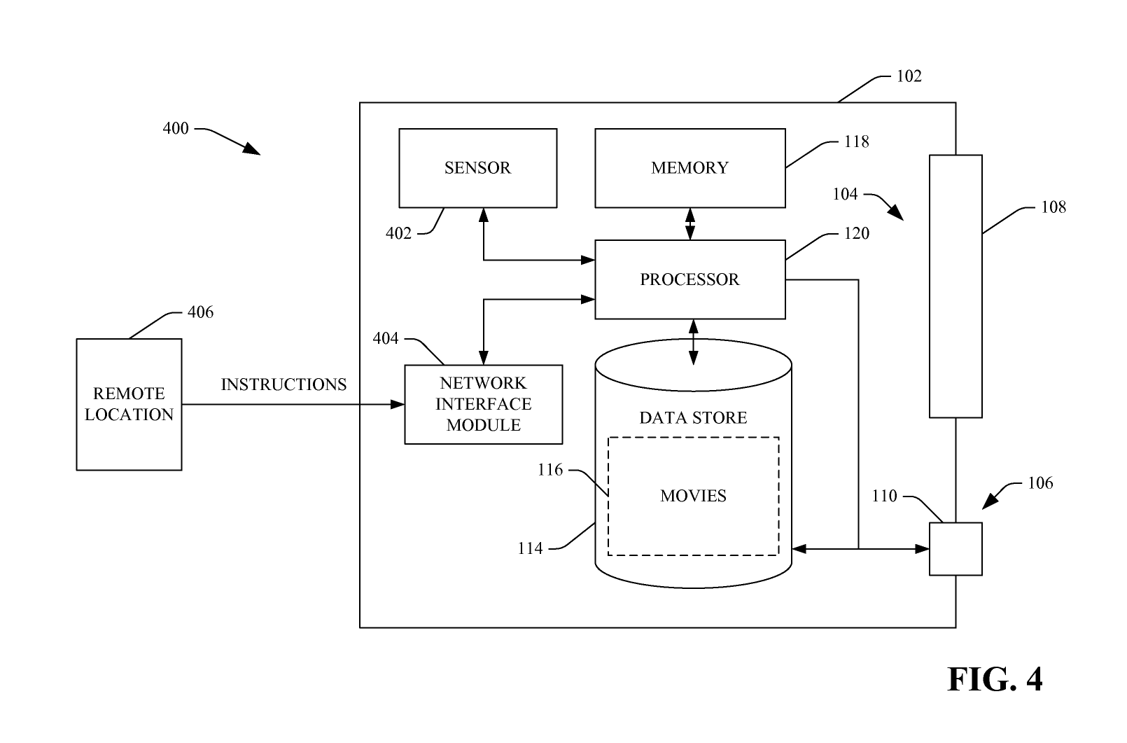

Referring now to FIG. 4, an example apparatus 400 that facilitates renting or selling a movie to a user is illustrated. The apparatus 400 includes the housing 102, the display screen 108, the interface module 110, the data store 114, the memory 118, and the processor 120, which act in conjunction as described above. The apparatus 400 also includes a sensor 402 that can be configured to sense a condition that is indicative of the apparatus 400 being subject to tampering. For instance, the sensor 402 can be configured to detect that a payment device, such as a cash acceptor device, has been subject to tampering. In another example, the sensor 402 can be a motion detection sensor that detects that the apparatus 400 has been moved. The memory 118 may include instructions for initiating an alarm upon the sensor sensing the condition that is indicative of the apparatus 400 being subject to tampering. For instance, the memory 118 can include instructions for initiating an audible alarm. In another example, the memory 118 can include instructions for transmitting an alarm to a remote location, such as to law enforcement, to a remote manager of the apparatus 400, etc. Such an alarm may be transmitted by way of a network connection. In still yet another example, the sensor 402 can be configured to detect that a network connection to a server has been severed. The memory 118 may include instructions for automatically preventing movies from being transmitted from the data store 114 based at least in part upon the detection.

The apparatus 400 can also include a network interface module 404 that can be configured to receive communications from a remote location 406. For instance, the network interface module 404 may be a network card, a wireless transceiver, software corresponding thereto, and/or the like. Thus, the apparatus 400 may be managed from a remote location. The communications received from the remote location 406 may include instructions to alter content of the data store 114. In an example, the instructions may include instructions for removing a movie from the data store 114 (e.g., a movie that has been subject to a relatively small amount of interest). Further, the instructions may include instructions for adding a movie to the data store 114 (e.g., a new release). A movie can be transmitted from the remote location 406 to the network interface module 404, and in turn can be added to the data store 114. Furthermore, the processor 120 can be configured to carry out such instructions.

In another example, the network interface module 404 can be configured to transmit payment information to the remote location 406. For example, credit card transactions can be transmitted to the remote location 406 for confirmation that the credit card is valid. In another example, debit card transactions can be transmitted to the remote location 406 for confirmation that a corresponding account has sufficient funds to rent or purchase a movie.

In still yet another example, the sensor 402 can be configured to monitor network status. For instance, the sensor 402 can determine that the apparatus 400 is no longer in communication with the remote location 406 (e.g., due to a network failure). This condition may be provided to the processor 120, which can act to power down the apparatus 400 and/or to illustrate to a user that the apparatus is not available for use (e.g., the user cannot rent or purchase a movie).

Furthermore, as noted above, the apparatus 400 may be managed from the remote location 406. Contracts can be established with local vendors for servicing hardware issues with the apparatus 400. For instance, the apparatus 400 may be positioned at an airport, and a contract can be executed between the remote location 406 and a servicer of a vending machine. Thus, an individual need not be paid to be proximate to the apparatus 400.

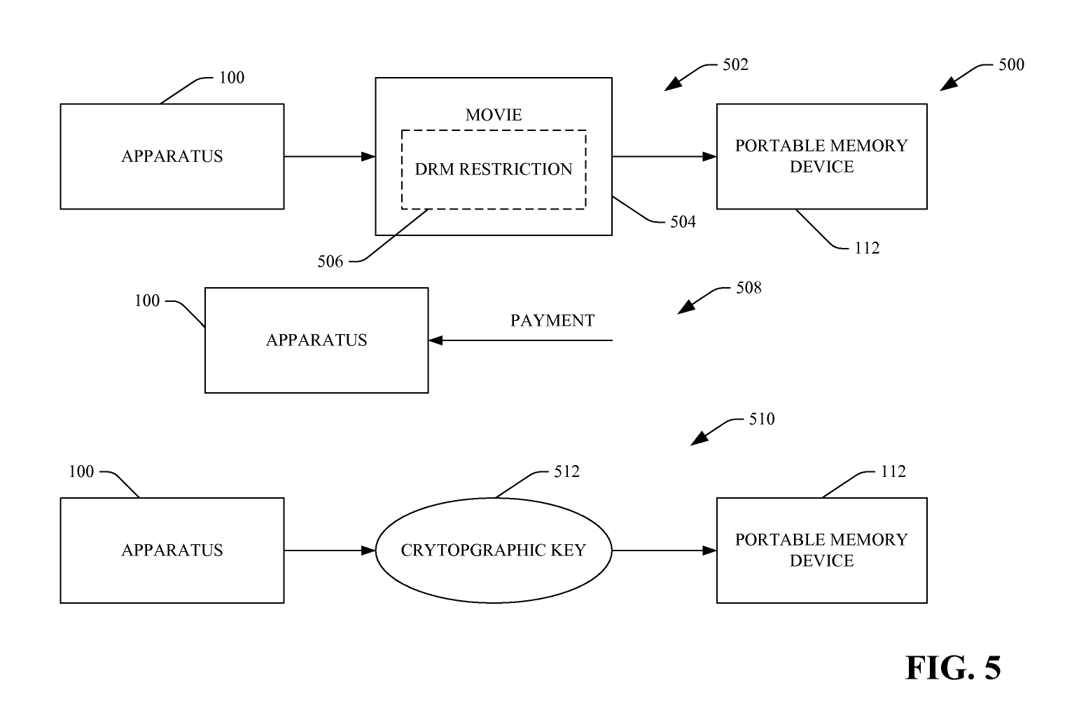

Referring now to FIG. 5, an example depiction of a timing diagram 500 is illustrated. At a first act 502, a movie 504 is transmitted from the apparatus 100 (FIG. 1) to the portable memory device 112. In an example, the portable memory device 112 can be a USB device, and a user can couple the portable memory device 112 to the apparatus 100 by way of a USB port (not shown). The user may determine that it is desirable to rent or purchase the movie 504, and can initiate transmission of the movie 504 from the apparatus 100. The portable memory device 112 can begin receiving the movie 504. Furthermore, as described above, the movie 504 may include at least one DRM restriction 506.

At a second act 508, the apparatus 100 receives payment for the movie 504. For instance, a user can provide a credit card number or debit card number to the apparatus 100. In another example, the apparatus 100 may include a cash acceptor, and the user can provide cash to the apparatus 100. In yet another example, the portable memory device 112 may include electronic funds, and such electronic funds can be transferred from the portable memory device 112 to the apparatus 100.

At a third act 510, upon receipt of payment, the apparatus 100 can output a cryptographic key 512 to the portable memory device 112. In an example, the cryptographic key may include a public key/private key pair. In another example, the cryptographic key may be a private key. It is to be understood that any suitable cryptographic key can be employed, such that a user cannot access the movie on the portable memory device 112 without the cryptographic key 512.

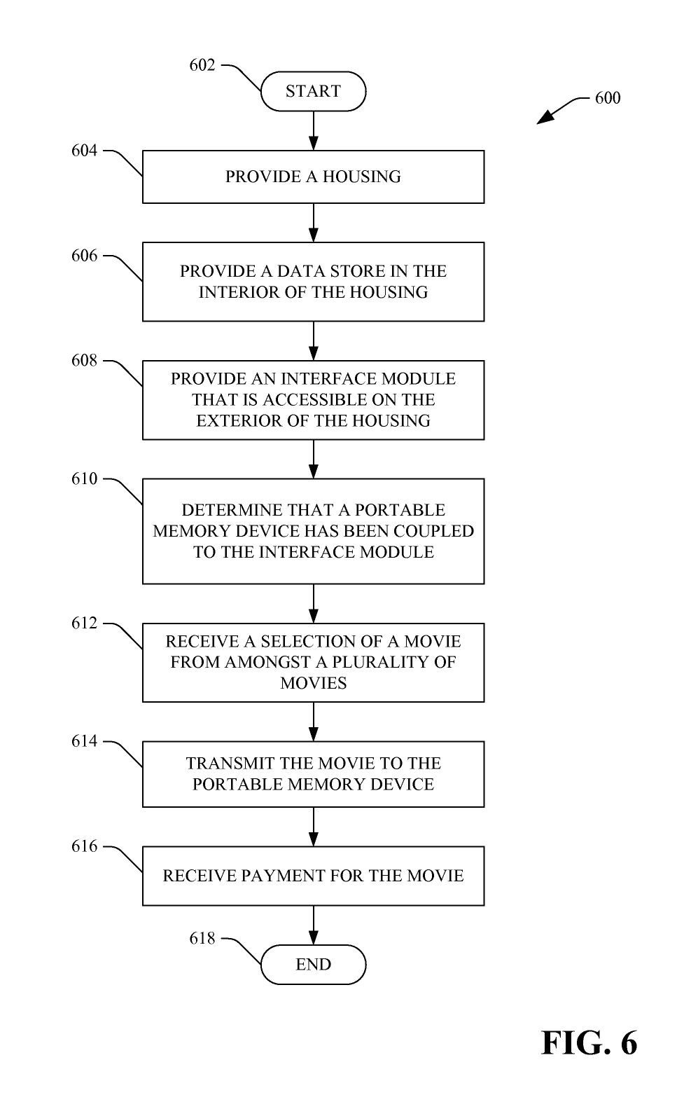

With reference now to FIGS. 6-9, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring specifically to FIG. 6, an example methodology 600 for outputting a movie for rental or purchase is illustrated. The methodology 600 starts at 602, and at 604 a housing is provided, wherein the housing can have an interior and an exterior. The housing, for instance, may be composed of a hard plastic, a metal, a carbon fiber, or other suitable material.

At 606, a data store is provided in the interior of the housing, wherein the data store can comprise a plurality of rentable movies. Pursuant to an example, the data store may have at least one terabyte of storage capacity.

At 608, an interface module is provided that is accessible on the exterior of the housing. For instance, the interface module can be configured to receive a portable memory apparatus, such as a USB flash memory device. Furthermore, the interface module may be communicatively coupled to the data store (e.g., by way of a bus).

At 610, a determination is made that a portable memory device has been coupled to the interface module. For example, it can be determined that a USB memory device has been coupled to a USB port.

At 612, a selection of a movie from amongst a plurality of movies is received. In an example, a user may select a movie by selecting a graphical representation of such movie on a touch-sensitive screen. In another example, the user may select the movie by depressing a particular sequence of keystrokes. Further, the user may select the movie by using a pointing and clicking mechanism, such as a mouse. In yet another example, the user may select the movie by way of voice commands.

At 614, the movie is transmitted to the portable memory device (e.g., from the data store). In an example, transmission of a full-length movie to the portable memory device may take less than one minute. In another example, transmission of a full-length movie to the portable memory device may take less than two minutes.

At 616, payment is received for the movie. As noted above, the payment may be in electronic funds, cash, by way of a credit or debit card, etc. The methodology 600 completes at 618.

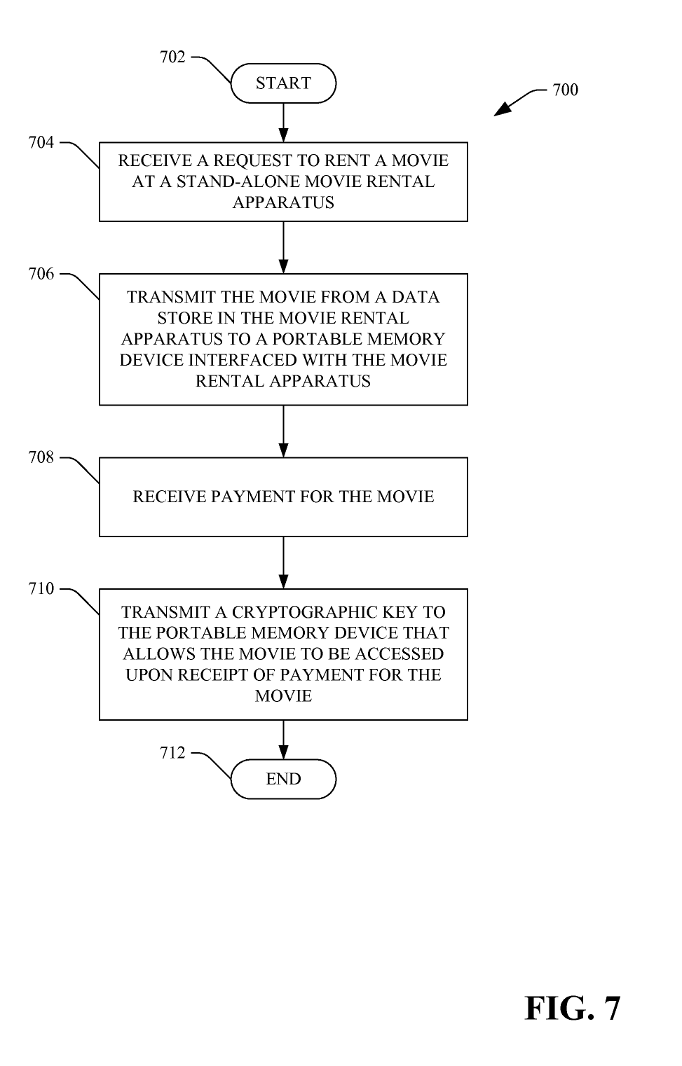

Now referring to FIG. 7, an example methodology 700 for transmitting a movie and a cryptographic key to a user is illustrated. The methodology 700 starts at 702, and at 704 a request to rent a movie is received at a stand-alone movie rental apparatus. As used herein, the term “stand-alone” refers to a movie rental apparatus that includes a data store that retains movies that are available for rent. Thus, a movie requested for rental is not transmitted to a user by way of a network.

At 706, the movie is transmitted from a data store in the movie rental apparatus (e.g., a hard drive) to a portable memory device that is interfaced with the movie rental apparatus. At 708, payment is received for the movie. More particularly, the payment can be received while the movie is being transmitted from the data store to the portable memory device.

At 710, after payment has been received, a cryptographic key is transmitted to the portable memory device, wherein the cryptographic key allows the movie to be accessed upon receipt of payment for the movie. More specifically, the cryptographic key may be used to decrypt the movie on the portable memory device. The methodology 700 completes at 712.

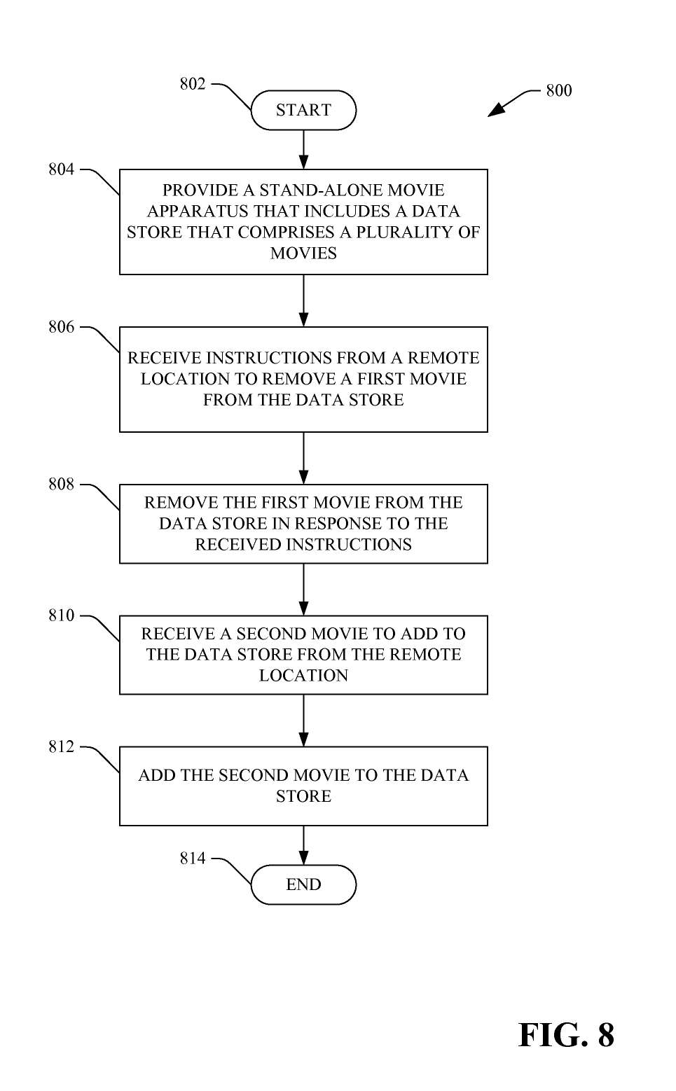

With reference now to FIG. 8, an example methodology 800 that facilitates updating a data store in a movie rental apparatus is illustrated. The methodology 800 starts at 802, and at 804 a stand-alone movie apparatus that includes a data store is provided, wherein the data store comprises a plurality of movies that are available for rental or purchase.

At 806, instructions are received from a remote location to remove a first movie from the data store. For instance, such movie may be subject to a relatively small amount of demand in comparison with demand corresponding to other movies in the data store.

At 808, the first movie is removed from the data store in response to the received instructions. At 810, a second movie is received (e.g., by way of a network) from a remote location, wherein it is desirable to add the second movie to the data store. Once the second movie is added, it may be rented or purchased by users of the movie rental apparatus. At 812, the second movie is added to the data store, and the methodology 800 completes at 814.

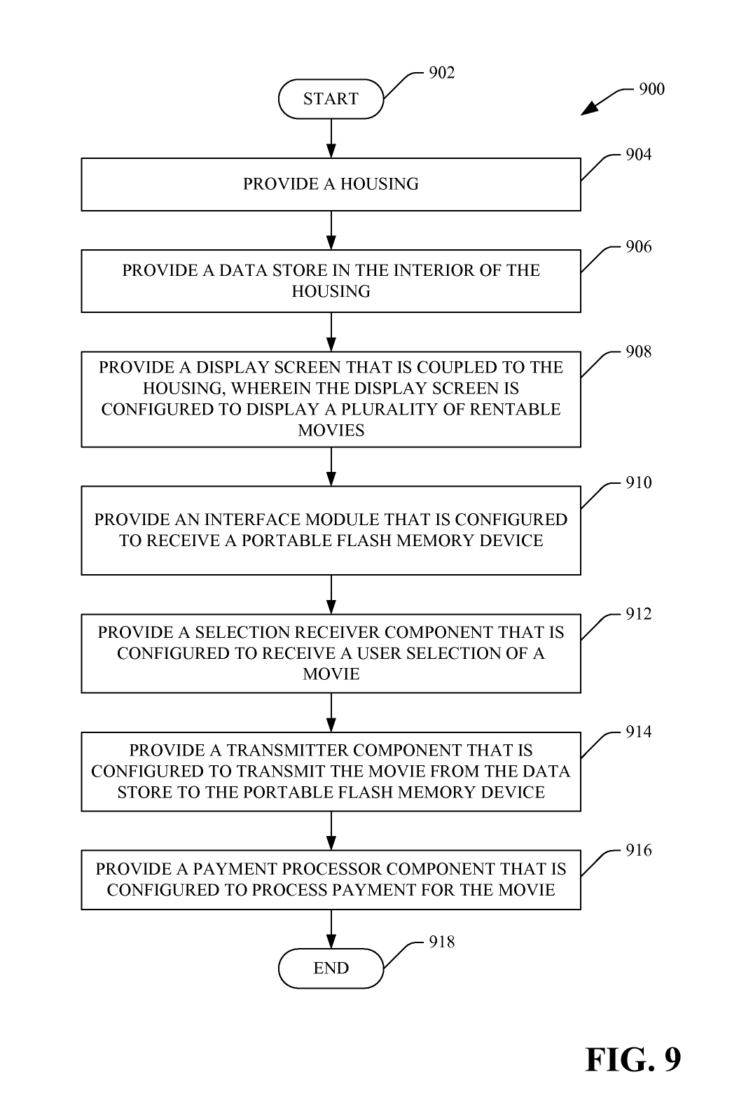

Now referring to FIG. 9, an example methodology 900 that facilitates transmitting a movie to a user is illustrated. The methodology 900 starts at 902, and at 904 a housing is provided, wherein the housing has an interior, an exterior, a first aperture, and a second aperture.

At 904, a data store is positioned in the interior of the housing, wherein the data store includes a plurality of rentable movies. At 906, a display screen provided, wherein the display screen is coupled to the housing (e.g., placed in the first aperture of the housing). The display screen can be configured to display a plurality of rentable movies that can be selected by a user.

At 908, an interface module is provided that is configured to receive a portable flash memory device. For instance, the interface module may be positioned in the second aperture of the housing, and may be accessible on the exterior of the housing.

At 910, a selection receiver component is provided, wherein the selection receiver component can be configured to receive a selection of a movie from the user. At 912, a transmitter component is provided, wherein the transmitter component can be configured to transmit the movie from the data store to the portable flash memory device.

At 914, a payment processor component is provided, wherein the payment processor component can be configured to process payment for the movie from the user. The methodology 900 completes at 916.

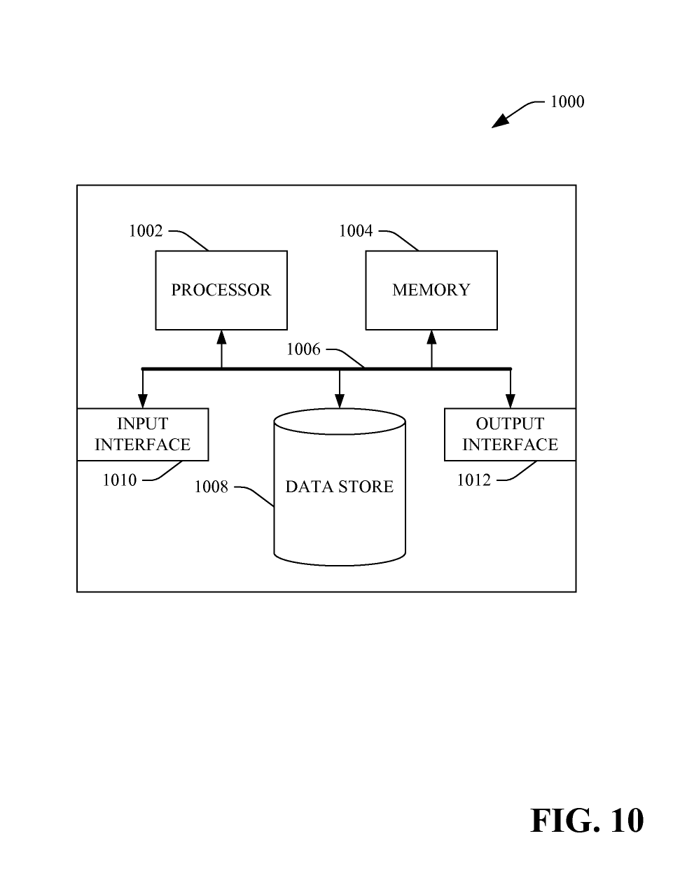

Now referring to FIG. 10, a high-level illustration of an example computing device 1000 that can be used in accordance with the systems and methodologies disclosed herein is illustrated. For instance, the computing device 1000 may be used in a system that can be used in connection with determining and outputting customized investing advice for a user. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory by way of a system bus 1006. In addition to storing executable instructions, the memory 1004 may also store movies, music, portions of a graphical user interface, electronic funds, cryptography keys, etc.

The computing device 1000 additionally includes a data store 1008 that is accessible by the processor 1002 by way of the system bus 1006. The data store 1008 may include executable instructions, movies, cryptography keys, etc. The computing device 1000 also includes an input interface 1010 that allows external devices to communicate with the computing device 1000. For instance, the input interface 1010 may be used to receive instructions from an external computer device, receive a movie to be added to the data store 1008, etc. The computing device 1000 also includes an output interface 1012 that interfaces the computing device 1000 with one or more external devices. For example, the computing device 1000 may transmit a movie to a user by way of the output interface 1012.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. An apparatus, comprising:
a housing, wherein the housing includes a first aperture and a second aperture;
a display screen located in the first aperture of the housing;
an interface module located in the second aperture of the housing, wherein the interface module is configured to receive a portable memory device;
a data store that is communicatively coupled to the interface module, wherein the data store includes a plurality of movies available for rent or purchase to a user;
a memory that includes instructions for:
displaying a graphical user interface on the display screen, wherein the graphical user interface is configured to receive a selection of a movie from amongst the plurality of movies from the user;
transmitting the movie from the data store to the portable memory device; and
processing payment for rental or purchase of the movie from the user; and
a processor that is configured to execute instructions in the memory.

2. The apparatus of claim 1, wherein the interface module is configured to receive a portable flash memory device.

3. The apparatus of claim 1, wherein the interface module includes a Universal Serial Bus port.

4. The apparatus of claim 1, further comprising a cash acceptor that is configured to receive cash from the user for payment for rental or purchase of the movie.

5. The apparatus of claim 1, further comprising a card reader apparatus that is configured to read at least one of a credit card or a debit card, wherein the instructions for processing payment include instructions for charging a credit card a fee for rental or purchase of the movie.

6. The apparatus of claim 1, wherein the plurality of movies in the data store include digital rights management restrictions.

7. The apparatus of claim 6, wherein the digital rights management restrictions comprise a restriction on a window of time within which the movie can be watched.

8. The apparatus of claim 6, wherein the digital rights management restrictions comprise a restriction on a number of times that the movie can be watched.

9. The apparatus of claim 1, further comprising a sensor that is configured to sense a condition that is indicative of the apparatus being subject to tampering, and wherein the memory includes instructions for initiating an alarm upon the sensor sensing the condition.

10. The apparatus of claim 1, further comprising a network interface module that is configured to receive communications from a remote location, wherein the memory includes instructions for altering content of the data store based at least in part upon communications received from the remote location.

11. The apparatus of claim 1, wherein processing payment for rental or purchase of the movie from the user comprises processing payment from an online account.

12. The apparatus of claim 1, wherein the memory includes additional instructions for transmitting a cryptographic key to the portable memory device, wherein the cryptographic key decrypts the movie.

13. A method for renting or selling a movie to a user, comprising:
providing a housing that has an interior and an exterior;
including a data store in the interior of the housing, wherein the data store comprises a plurality of rentable or purchaseable movies;
providing an interface module that is accessible on the exterior of the housing, wherein the interface module is configured to receive a portable memory device, wherein the interface module is communicatively coupled to the data store;
determining that the portable memory device has been coupled to the interface module;
receiving a selection of a movie from amongst the plurality of movies;
transmitting the movie to the portable memory device; and
receiving payment for the movie.

14. The method of claim 13, further comprising transmitting a cryptographic key that decrypts the movie to the portable memory device.

15. The method of claim 13, wherein the movie includes at least one digital rights management restriction.

16. The method of claim 13, further comprising receiving electronic funds from the portable memory apparatus for payment for the movie.

17. The method of claim 13, further comprising outputting a graphical user interface, wherein the graphical user interface includes selectable graphical depictions of multiple movies in the data store.

18. The method of claim 13, further comprising:
receiving instructions from a remote location to alter contents of the data store; and
altering contents of the data store based at least in part upon the received instructions.

19. The method of claim 13, further comprising:
detecting that a network connection that communicatively couples the data store to a remote server has been severed; and
automatically preventing transmission of movies from the data store based at least in part upon the detection.

20. A stand-alone movie rental apparatus, comprising:
a housing, wherein the housing has an interior, an exterior, a first aperture, and a second aperture;
a data store positioned in the interior of the housing, wherein the data store includes a plurality of rentable movies;
a display screen that is positioned in the first aperture of the housing, wherein the display screen is configured to display a subset of the plurality of rentable movies for selection by a user;
an interface module that is positioned in the second aperture of the housing and is accessible from the exterior of the housing, wherein the interface module is configured to receive a portable flash memory device;
a selection receiver component that receives a selection of a movie that is desirably rented by the user;
a transmitter component that transmits the movie from the data store to the portable flash memory device upon receipt of the selection of the movie; and
a payment processor component that processes payment for the movie.
